(19) United States
(12) Patent Application Publication
(10) Pub. No.: US 2003/0190522 A1
(43) Pub. Date: Oct. 9, 2003

(54) Thin battery connection structure and battery pack

(75) Inventor: Shinya Ogata, Isehara-shi (JP)

Correspondence Address: McDERMOTT, WILL & EMERY, 600 13th Street, N.W., Washington, DC, 20005-3096, US

(73) Assignee: NISSAN MOTOR CO., LTD.

(21) Appl. No.: 10/401,605

(22) Filed: Mar. 31, 2003

(30) Foreign Application Priority Data
Apr. 8, 2002 (JP) 2002-104912

(51) Int. Cl. H01M 2/02

(52) U.S. Cl. 429/179; 429/121; 429/123; 429/162

(57) ABSTRACT

A first subassembly and a second subassembly each include four thin batteries connected in parallel with positive terminals of the individual thin batteries connected through a positive-side bus bar having a projecting portion and negative terminals of the individual thin batteries connected through a flat negative-side bus bar. The first subassembly is stacked on top of the second subassembly. The projecting portion of the positive-side bus bar at the second subassembly comes into contact with the negative-side bus bar of the first subassembly to achieve a serial connection between the first subassembly and the second subassembly.

### BACKGROUND OF THE INVENTION

1. Field of the Invention

The present invention relates to a thin battery connection technology and, more specifically it relates to a thin battery connection structure and a battery pack that facilitate connection of thin batteries.

2. Description of the Related Art

As thin batteries have come to be utilized in increasingly diverse applications under increasingly diverse operating conditions, it has become critical to achieve higher voltages and larger capacities, and a technology whereby a plurality of thin batteries are connected has been proposed as a means for meeting this need.

Japanese Laid-Open Patent Publication No. H 9-259859 discloses a method of connecting thin batteries by stacking the thin batteries each having a pair of indented portions each formed at a peripheral end edge and terminals led out at the indented portions.

### SUMMARY OF THE INVENTION

However, while it is necessary to connect the terminals of the individual thin batteries when stacking the thin batteries through the technology described above, the flat bus bars in the related art used to connect cylindrical or angular batteries cannot be used in conjunction with thin batteries in a satisfactory manner since it is becoming more difficult to assure sufficient space for the bus bars to be connected to the batteries, miniaturization of which has been pursued aggressively.

The present invention is to provide a thin battery connection structure and a battery pack that facilitate connection of thin batteries.

A thin battery connection structure according to the present invention electrically connects a positive terminal and a negative terminal of one thin battery which are led out at peripheral portions of a battery armor each to either a positive terminal and a negative terminal of at least one other thin battery by using bus bars. In the present invention, a projecting portion is formed at at least one bus bar of the bus bars to achieve an electrical connection with another thin battery other than the tin batteries.

A battery pack according to the present invention comprises a plurality of thin batteries each having a positive terminal and a negative terminal led out at peripheral portions of a battery armor, and bus bars electrically connecting in parallel the positive terminal and the negative terminal of one thin battery each to either a positive terminal or a negative terminal of at least one other thin battery. In the present invention, a projecting portion is formed at at least one bus bar of the bus bars to achieve an electrical connection with another battery pack.

### BRIEF DESCRIPTION OF THE DRAWINGS

FIG. 1 is a perspective of the thin battery achieved in the first embodiment of the present invention.

FIG. 2 is a sectional view taken along I-I in FIG. 1.

FIG. 3 is a perspective of the subassembly achieved in the first embodiment of the present invention, viewed from the negative side.

FIG. 4 is a perspective of the subassembly achieved in the first embodiment of the present invention, viewed from the positive side.

FIG. 5 is a side elevation of the subassembly achieved in the first embodiment of the present invention, viewed from the negative side.

FIG. 6 is a side elevation of the subassembly achieved in the first embodiment of the present invention, viewed from the positive side.

FIG. 7 is a side elevation of the essential portion of the projecting portion projecting upward along the vertical direction at the positive-side bus bar in the first embodiment of the present invention.

FIG. 8 is a circuit diagram of the subassembly achieved in the first embodiment of the present invention.

FIG. 9 is a perspective of an assembly achieved by stacking two subassemblies in the first embodiment of the present invention.

FIG. 10 is a side elevation of the assembly achieved by stacking two subassemblies in the first embodiment of the present invention, taken on one side of the assembly.

FIG. 11 is a side elevation of the assembly achieved by stacking two subassemblies in the first embodiment of the present invention, taken on the other side of the assembly.

FIG. 12 is a circuit diagram of the assembly achieved by stacking two subassemblies in the first embodiment of the present invention.

FIG. 13 is a perspective of an assembly achieved by stacking four subassemblies in the first embodiment of the present invention.

FIG. 14 is a side elevation of the assembly achieved by stacking four subassemblies in the first embodiment of the present invention, taken on one side of the assembly.

FIG. 15 is a side elevation of the assembly achieved by stacking four subassemblies in the first embodiment of the present invention, taken on the other side of the assembly.

FIG. 16 is a circuit diagram of the assembly achieved by stacking four subassemblies in the first embodiment of the present invention.

FIG. 17 is a perspective of the subassembly achieved in the second embodiment of the present invention, viewed from the negative side.

FIG. 18 is a circuit diagram of the subassembly achieved in the second embodiment of the present invention.

FIG. 19 is a side elevation of an assembly achieved by stacking four subassemblies in the second embodiment of the present invention, taken on one side of the assembly.

FIG. 20 is a side elevation of the assembly achieved by stacking four subassemblies in the second embodiment of the present invention, taken on the other side of the assembly.

FIG. 21 is a circuit diagram of the assembly achieved in the second embodiment of the present invention.

FIG. 22 is a perspective of the subassembly achieved in the third embodiment of the present invention, viewed from the negative side.

FIG. 23 is a perspective of the subassembly achieved in the third embodiment of the present invention, viewed from the positive side.

FIG. 24 is a side elevation of the essential portions of the projecting portion projecting upward along the vertical direction at the positive-side bus bar and the projecting portion projecting downward along the vertical direction at the negative-side bus bar in the third embodiment of the present invention.

FIG. 25 is a side elevation of an assembly achieved by stacking subassemblies in the third embodiment of the present invention, taken on one side of the assembly.

FIG. 26 is a side elevation of the assembly achieved by stacking subassemblies in the third embodiment of the present invention, taken on the other side of the assembly.

FIG. 27 is a perspective of the subassembly achieved in the fourth embodiment of the present invention, viewed from the negative side.

FIG. 28 is a side elevation of an assembly achieved by stacking subassemblies in the fourth embodiment of the present invention, taken on one side of the assembly.

FIG. 29 is a side elevation of the assembly achieved by stacking subassemblies in the fourth embodiment of the present invention, taken on the other side of the assembly.

### DESCRIPTION OF THE PREFERRED EMBODIMENTS

The following is an explanation of embodiments of the present invention, given in reference to the drawings.

(First Embodiment)

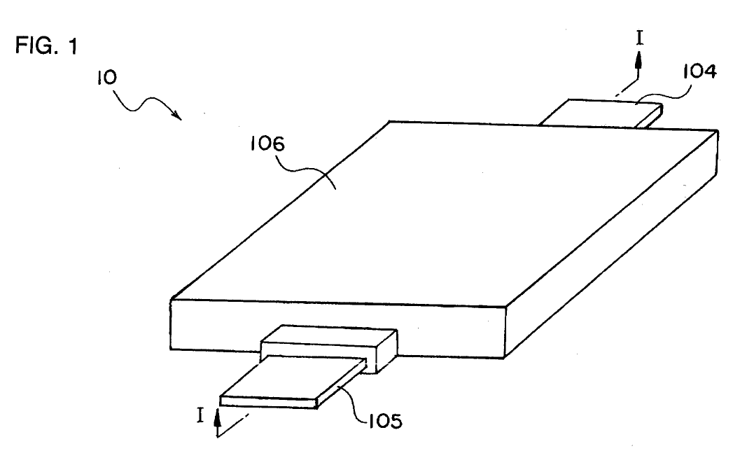

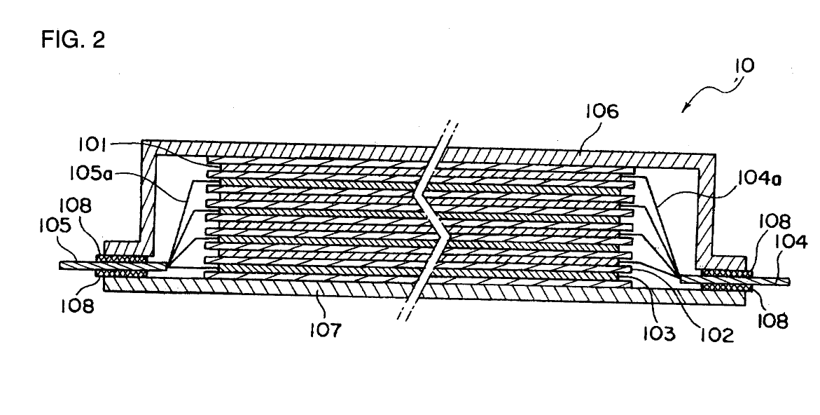

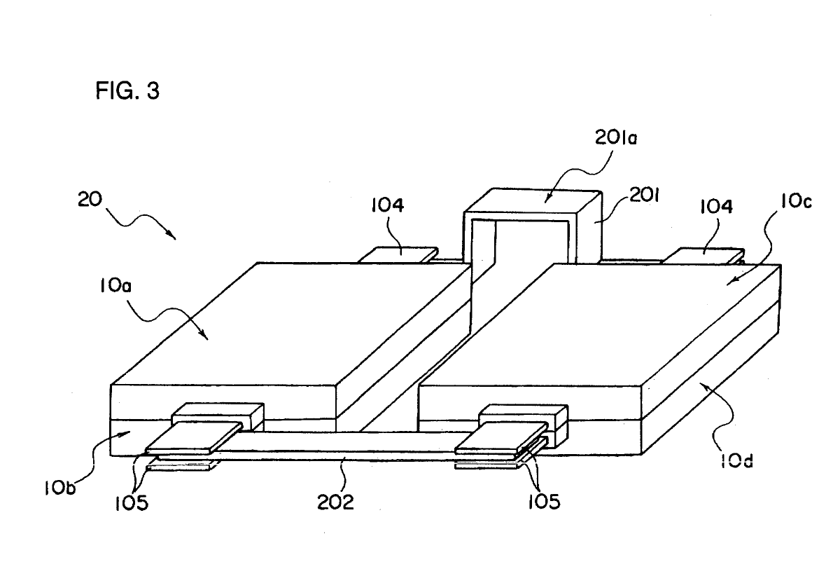

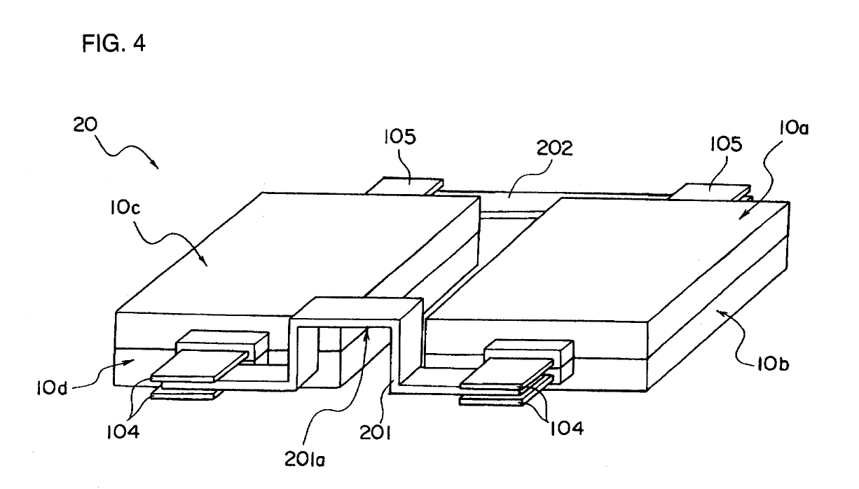

FIG. 1 is a perspective of a thin battery 10 achieved in the first embodiment of the present invention and FIG. 2 is a sectional view taken along I-I in FIG. 1. FIGS. 3 and 4 present perspectives of a subassembly 20 (battery pack is achieved by stacking the thin batteries 10 achieved in the first embodiment of the present invention.

As shown in FIGS. 1 and 2, the thin battery 10 comprises positive plates 101, separators 102, negative plates 103, a positive terminal, a negative terminal 105, an upper battery armor 106 and a lower battery armor 107.

Inside the thin battery 10, four positive plates 101, nine separators 102 that prevent contact between the positive pole and the negative pole and the like and four negative plates 103 are provided.

The thin battery 10 is constituted by alternately stacking, from the top down, the positive plates 101 and the negative plates 103, with the separators 102 inserted between the positive plates 101 and the negative plates 103 and a separator 102 provided both at the top and at the bottom of the layers. The four positive plates 101 are each connected to the positive terminal 104 via a positive-side connecting wire 104a, whereas the four negative plates 103 are each connected to the negative terminal 105 via a negative-side connecting wire 105a. It is to be noted that the quantities of the positive plates, the separators and the negative plates in the thin battery 10 are not limited to those described above, and their quantities may be set to any values as appropriate, as long as they are stacked in the order explained above.

The upper battery armor 106 and the lower battery armor 107 seal the pluralities of positive plates 101, the separators 102 and the negative plates 103 stacked in the order described above. At the end of the battery armors 106 and 107 sealing the layered structure on one side, the positive terminal 104 is led out. In order to keep the inside of the thin battery 10 in a sealed state, a terminal seal 108 is applied over the areas where the positive terminal 104 comes in contact with the battery armors 106 and 107. Likewise, at the ends of the battery armors 106 and 107 sealing the layered structure on the other side, the negative terminal 105 is led out, with a terminal seal 108 applied over the areas where the negative terminal 105 comes in contact with the battery armors 106 and 107.

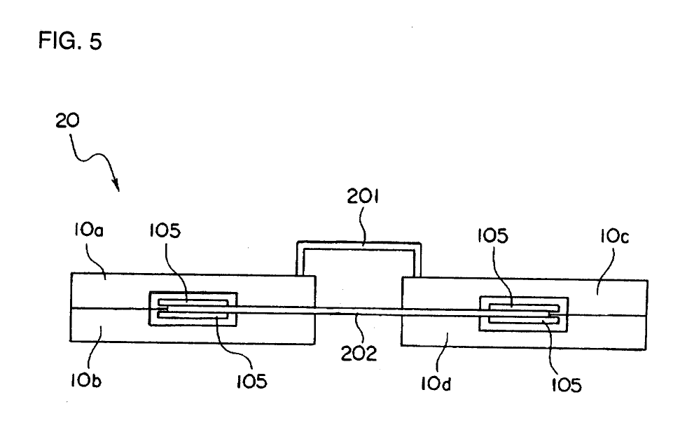

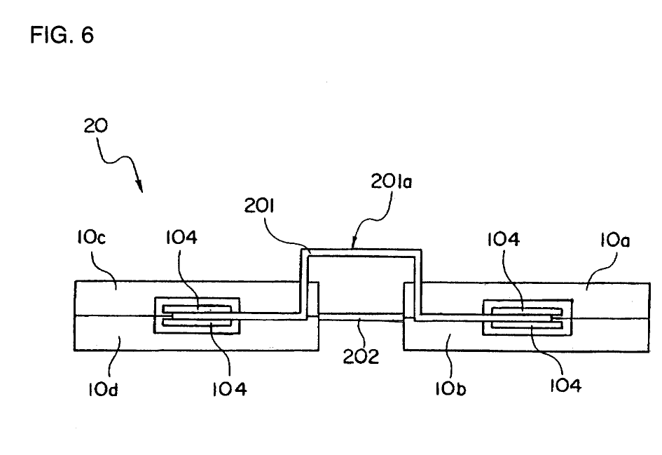

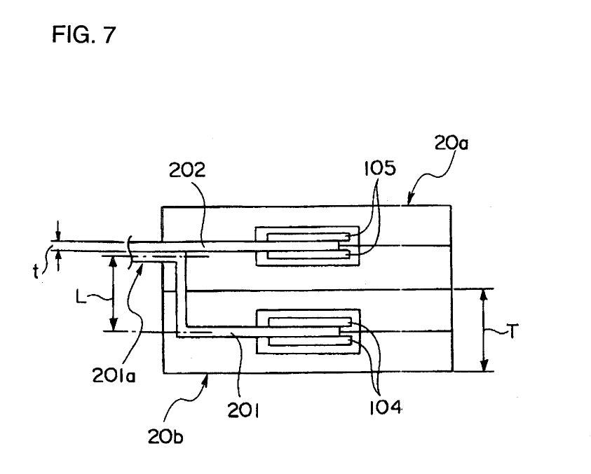

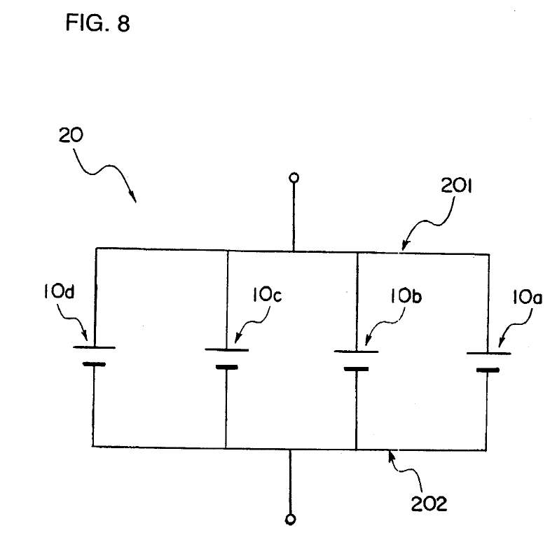

FIG. 3 is a perspective of the subassembly 20 achieved in the first embodiment of the present invention, viewed from the negative side, whereas FIG. 4 is a perspective of the subassembly 20 viewed from the positive side. In addition, FIG. 5 presents a side elevation of the subassembly 20 viewed from the negative side and FIG. 6 presents a side elevation of the subassembly 20 viewed from the positive side. FIG. 7 is a side elevation of the essential portion of a projecting portion 201a of a positive-side bus bar 201. FIG. 8 is a circuit diagram of the subassembly.

As shown in FIGS. 3 through 6, the subassembly 20 achieved in the first embodiment of the present invention includes four thin batteries 10a˜10d, the positive-side bus bar 201 and a negative-side bus bar 202. The positive-side bus bar 201 and the negative-side bus bar 202, which respectively connect the positive terminals 104 and the negative terminal 105 of the plurality of thin batteries 10, are constituted of a material achieving electrical conductivity such as a metal.

As shown in FIG. 4, the positive-side bus bar 201 has a range which makes it possible for it to connect with all the positive terminals 104 present at the layer corresponding to the four thin batteries 10a˜10d. As shown in FIG. 3, the negative-side bus bar 202 has a range which makes it possible for it to connect with all the negative terminals 105 present at the layer corresponding to the four thin batteries 10a˜10d.

The positive-side bus bar 201 includes the projecting portion 201a projecting upward along the vertical direction at its center, whereas the negative-side bus bar 202 is formed in a flat shape. The length L over which the projecting portion 201a extends upward along the vertical direction is large enough to allow the projecting portion 201a formed at the positive-side bus bar 201 of the subassembly 20 to come into full contact with the negative-side bus bar 202 of another subassembly 20 stacked on the subassembly 20 as explained in detail later referring to FIG. 7. This may be, for instance, a distance substantially equal to a numerical value calculated based upon the relational expression L=T−t, with T representing the thickness of the subassembly 20 and t representing the plate thickness of the negative-side bus bar 202 when the plate thickness of the positive-side bus bar 201 and the negative-side bus bar 202 are substantially equal to each other at t. It is to be noted that the positive-side bus bar 201 may be formed in a flat shape and the negative-side bus bar 202 may include a projecting portion with a downward projection along the vertical direction, instead.

In the subassembly 20, the first thin battery 10a and the second thin battery 10b with its top side and bottom side reversed from those of the first thin battery 10a are stacked together so that their positive poles face the same direction, and likewise, the third thin battery 10c and the fourth thin battery 10d with its top side and bottom side reversed from those of the third thin battery 10c are stacked together so that their positive poles face the same direction.

With these two stacks with the positive poles facing the same direction, the positive-side bus bar 201 having its projecting portion 201a projecting upward along the vertical direction is connected to the positive terminal 104 of the first thin battery 10a and the positive terminal 104 of the second thin battery 10b at the stack constituted of the first and second thin batteries 10a and 10b. In the addition, the positive-side bus bar 201 is connected to the positive terminal 104 of the third thin battery 10c and the positive terminal 104 of the fourth thin battery 10d at the stack constituted of the third and fourth thin batteries 10c and 10d.

Likewise, the negative-side bus bar 202 is connected to the negative terminal 105 of the first thin battery 10a and the negative terminal 105 of the second thin battery 10b at the stack constituted of the first and second thin batteries 10a and 10b. The negative-side bus bar 202 is also connected to the negative terminal 105 of the third thin battery 10c and the negative terminal 105 of the fourth thin battery 10d at the stack constituted of the third and fourth thin batteries 10c and 10d.

As described above, the subassembly 20 includes the positive-side bus bar 201 with its projecting portion 201a projecting upward along the vertical direction provided on the positive side and the flat negative-side bus bar 202 provided on the negative side, with all the terminals with matching polarity facing the same direction. As a result, the subassembly 20 connected as described above forms a circuit in which the four thin batteries 10a˜10d are connected in parallel by the positive-side bus bar 201 and the negative-side bus bar 202, as shown in FIG. 8.

An assembly 30 explained below is achieved by stacking a plurality of subassemblies 20 described above each constituting a component unit.

Now, the procedure taken to stack two subassemblies 20 is explained.

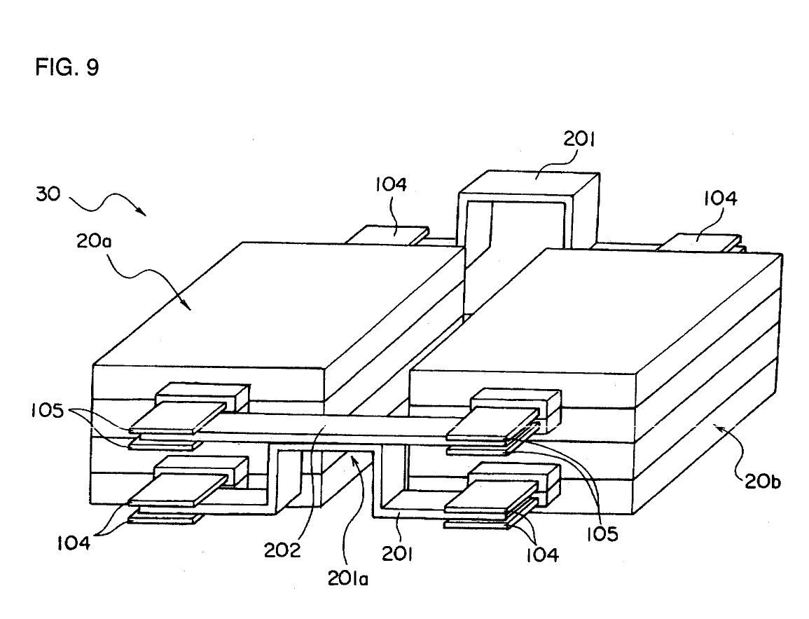

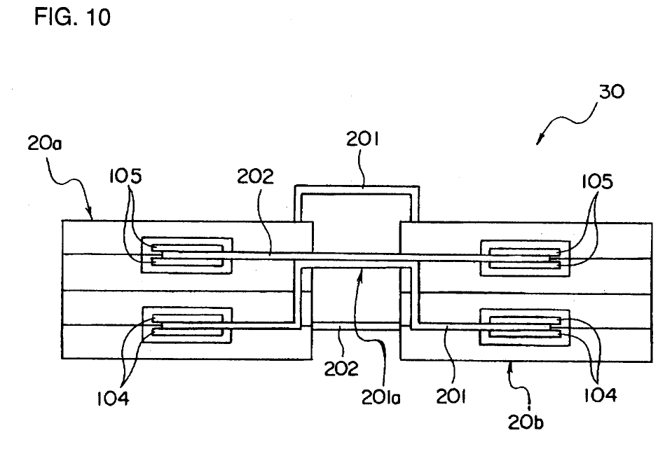

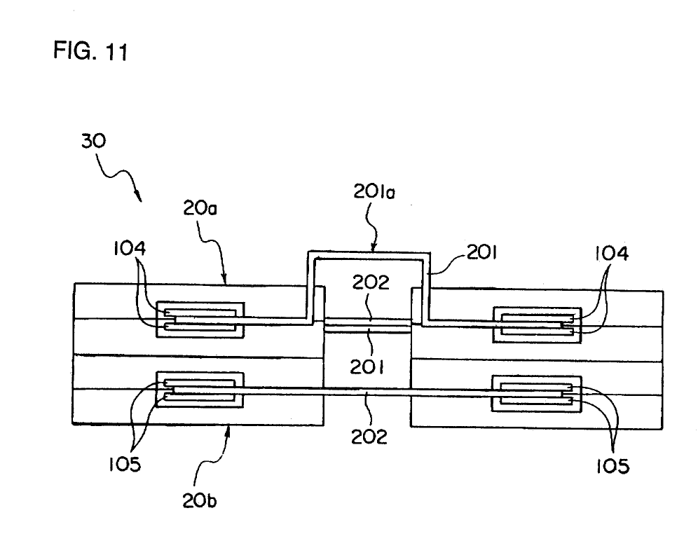

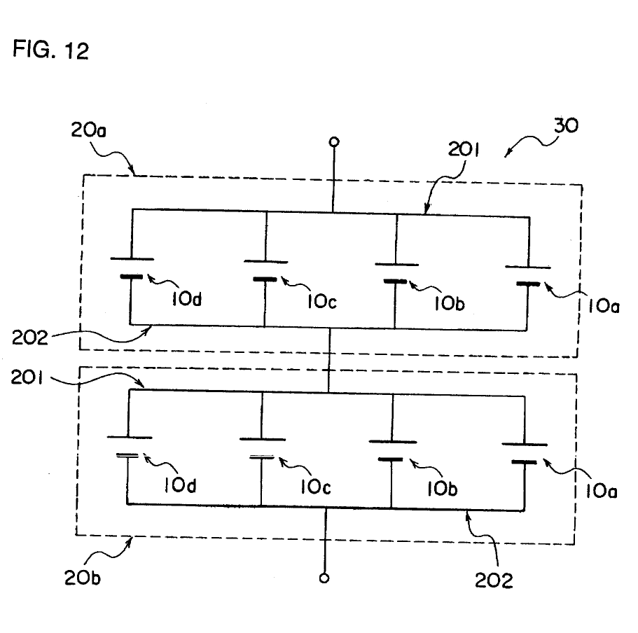

FIG. 9 is a perspective of the assembly 30 formed by stacking two subassemblies 20a and 20b achieved in the first embodiment of the present invention, and FIGS. 10 and 11 present side elevations of the assembly 30. FIG. 12 is a circuit diagram of the assembly 30.

As shown in FIGS. 9 through 11, the first subassembly 20a is stacked on top of the second subassembly 20b by setting the positive side of the second subassembly 20b and the negative side of the first subassembly 20a to face the same direction and setting the projecting portion 201a of the positive-side bus bar 201 of the second subassembly 20b to project upward along the vertical direction. By stacking them in this manner, the projecting portion 201a of the positive-side bus bar 201 provided in the second subassembly 20b comes in contact with the negative-side bus bar 202 of the first subassembly 20a, thereby achieving a connection between the first subassembly 20a and the second subassembly 20b.

As shown in FIG. 12, in the assembly 30 having the subassemblies connected as described above, the four thin batteries 10a˜10d connected in parallel at the first subassembly 20a and the four thin batteries 10a˜10d connected in parallel at the second subassembly 20b are connected in series through the contact of the negative-side bus bar 202 of the first subassembly 20a and the positive-side bus bar 201 of the second subassembly 20b.

Next, the procedure of stacking four subassemblies 20 is explained.

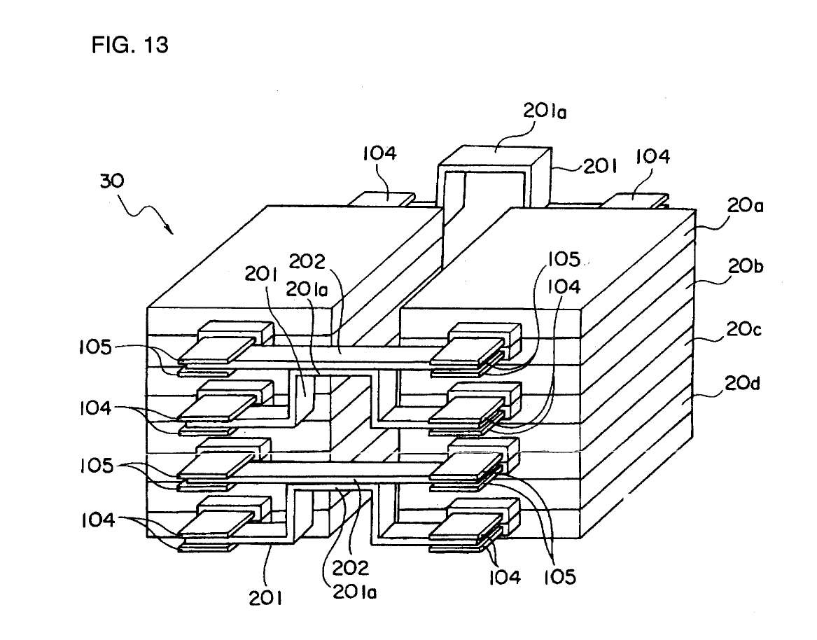

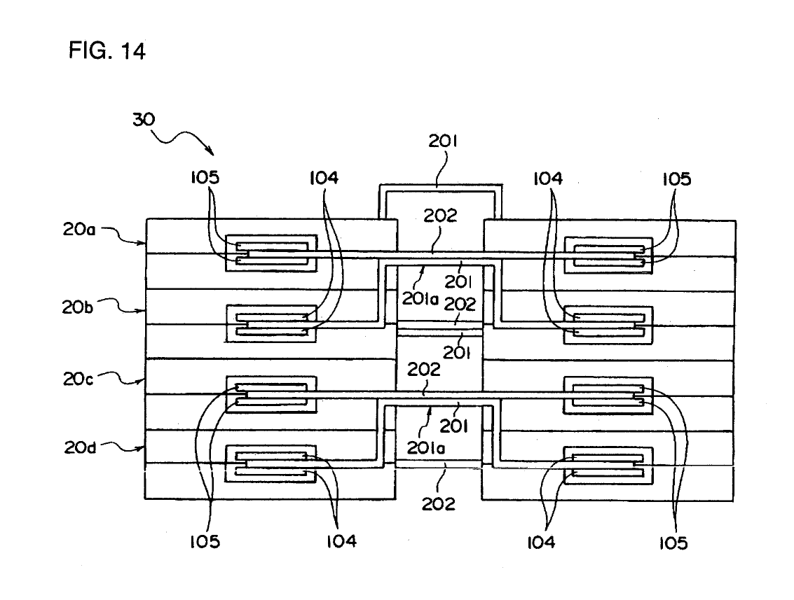

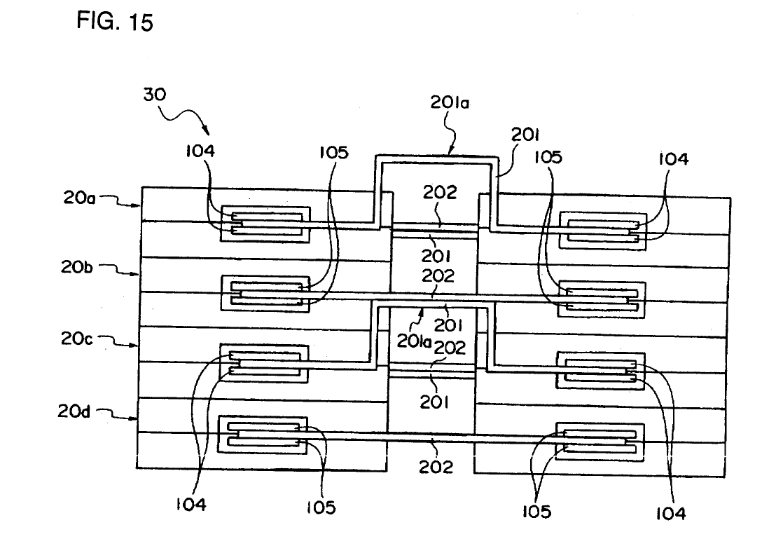

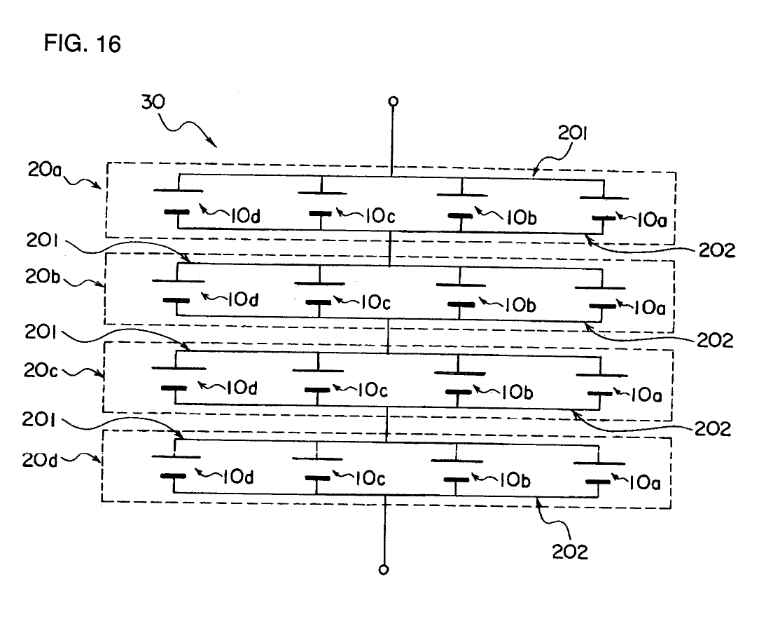

FIG. 13 is a perspective of an assembly 30 formed by stacking four subassemblies 20a˜20d achieved in the first embodiment of the present invention, and FIGS. 14 and 15 present side elevations of the assembly 30. FIG. 16 is a circuit diagram of the assembly 30.

As shown in FIGS. 13 through 15, with the positive side of the fourth subassembly 20d and the negative side of the third subassembly 20c facing the same direction and the projecting portion 201a of the positive-side bus bar 201 at the fourth subassembly 20d projecting upward along the vertical direction, the third subassembly 20c is stacked on top of the fourth subassembly 20d. With the subassemblies stacked in this manner, the projecting portion 201a of the positive-side bus bar 201 provided at the fourth subassembly 20d comes into contact with the negative-side bus bar 202 of the third subassembly 20c, thereby achieving a connection between the third subassembly 20c and the fourth subassembly 20d.

Next, with the positive side of the third subassembly 20c and the negative side of the second subassembly 20b facing the same direction and the projecting portion 201a of the positive-side bus bar 201 at the third subassembly 20c projecting upward along the vertical direction, the second subassembly 20b is stacked on top of the third subassembly 20c. With the subassemblies stacked in this manner, the projecting portion 201a of the positive-side bus bar 201 provided at the third subassembly 20c comes into contact with the negative-side bus bar 202 of the second subassembly 20b, thereby achieving a connection between the second subassembly 20b and the third subassembly 20c.

Then, with the positive side of the second subassembly 20b and the negative side of the first subassembly 20a facing the same direction and the projecting portion 201a of the positive-side bus bar 201 at the second subassembly 20b projecting upward along the vertical direction, the first subassembly 20a is stacked on top of the second subassembly 20b. With the subassemblies stacked in this manner, the projecting portion 201a of the positive-side bus bar 201 provided at the second subassembly 20b comes into contact with the negative-side bus bar 202 of the first subassembly 20a, thereby achieving a connection between the first subassembly 20a and the second subassembly 20b.

In the assembly 30, which includes the four subassemblies 20a˜20d stacked and connected so as to alternate the positive sides and the negative sides as described above, the four thin batteries 10a˜10d connected in parallel at the first subassembly 20a and the four thin batteries 10a˜10d connected in parallel at the second subassembly 20b are connected in series through the contact between the negative-side bus bar 202 of the first subassembly 20a and the positive-side bus bar 201 of the second subassembly 20b, as shown in FIG. 16. Likewise, through the contact between the negative-side bus bar 202 of each subassembly and the positive-side bus bar 201 of the adjacent subassembly, the four thin batteries 10a˜10d connected in parallel at the second subassembly 20b, the four thin batteries 10a˜10d connected in parallel at the third subassembly 20c and the four thin batteries 10a˜10d connected in parallel at the fourth subassembly 20d are connected in series.

By providing a bus bar having a projecting portion with one polarity and providing a flat bus bar with the other polarity in each thin battery subassembly, it becomes possible to achieve both a parallel connection and a serial connection with a single type of component unit.

In addition, since subassemblies can be connected with ease by simply stacking the subassemblies having such bus bars one on top of another, a required voltage or the like can be realized readily.

The presence of the projecting portion formed at each positive-side bus bar increases the area between the positive-side bus bar and the negative-side bus bar positioned under the positive-side bus bar along the vertical direction compared to the area between two flat bus bars, and thus, sufficient space for connecting the bus bars is secured to further facilitate the connection work.

While a bus bar formed as a flat plate in a subassembly that includes thin batteries with their upper battery armors and lower battery armors constituted of a flexible material such as a resin film or a laminated product achieved by laminating resin-metal thin films poses a risk of damage to the terminals and the terminal seals of the thin batteries caused by deformation of the bus bar, such deformation of the bus bar can be prevented by forming a projecting portion at the bus bar, and consequently, damage to the thin batteries can be prevented.

(Second Embodiment)

The following is an explanation of an embodiment of a subassembly which includes 8 thin batteries.

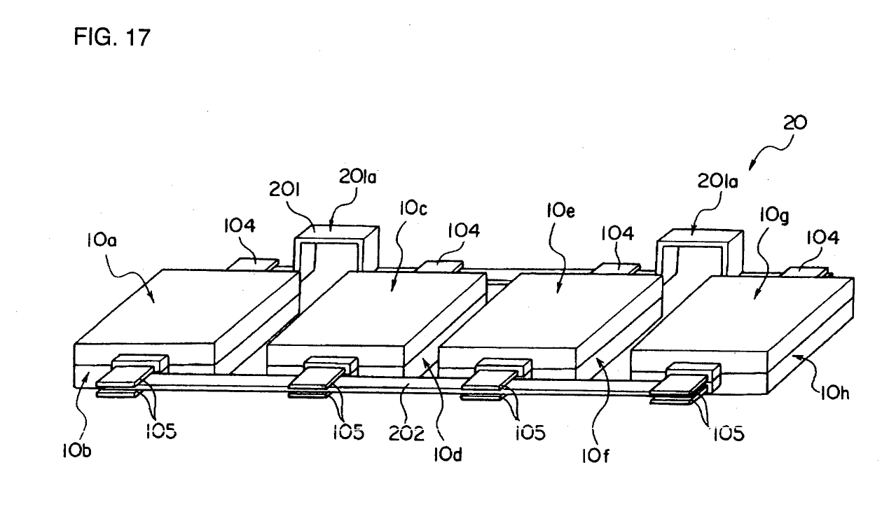

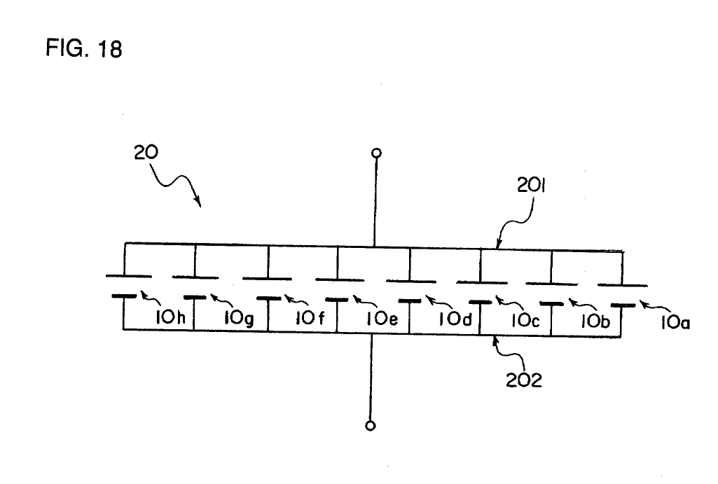

FIG. 17 is a perspective of a subassembly 20 achieved in the second embodiment of the present invention, viewed from the negative side. FIG. 18 is a circuit diagram of the subassembly 20. As shown in FIG. 17, the subassembly 20 comprises 8 thin batteries 10a˜10h, a positive-side bus bar 201 and a negative-side bus bar 202, with the thin batteries 10a˜10h adopting a structure similar to that of the thin batteries in the first embodiment.

The positive-side bus bar 201 and the negative-side bus bar 202 are members that respectively connect the positive terminals 104 and the negative terminals 105 at the plurality of thin batteries 10a˜10h and are each constituted of an electrically conductive material such as metal.

As shown in FIG. 17, the positive-side bus bar 201 has a range that allows the positive-side bus bar 201 to have contact with all the positive terminals 104 at the four stacks achieved with the eight thin batteries 10a˜10h. Likewise, the negative-side bus bar 202 has a range large enough to come into contact with all of the negative terminals 105 present at the four stacks achieved with the eight thin batteries 10a˜10h. In addition, the positive-side bus bar 201 includes two projecting portions 201a projecting upward along the vertical direction. One of the projecting portions 201a is formed between the stack constituted of the first and second thin batteries 10a and 10b and the stack constituted of the third and fourth thin batteries 10c and 10d. The other projecting portion 201a is formed between the stack constituted of the fifth and sixth thin batteries 10e and 10f and the stack constituted of the seventh and eighth thin batteries 10g and 10h. The length L over which the two projecting portions 201a extend upward along the vertical direction and the shape of the negative-side bus bar 202 match those adopted in the first embodiment.

It is to be noted that the positive-side bus bar 201 may be formed in a flat shape and the negative-side bus bar 202 may include two projecting portions projecting downward along the vertical direction, instead.

In the subassembly 20, the first thin battery 10a and the second thin battery 10b with its top side and bottom side reversed from those of the first thin battery 10a are stacked together so that their positive poles face the same direction. Likewise, the third thin battery 10c and the fourth thin battery 10d with its top side and bottom side reversed from those of the third thin battery 10c are stacked together so that their positive poles face the same direction. In addition, the fifth thin battery 10e and the sixth thin battery 10f with its top side and bottom side reversed from those of the fifth thin battery 10e are stacked together so that their positive poles face the same direction. Likewise, the seventh thin battery 10g and the eighth thin battery 10h with its top side and bottom side reversed from those of the seventh thin battery 10g are stacked together so that their positive poles face the same direction.

With the positive poles of the four stacks facing the same direction, the positive-side bus bar 201 with its two projecting portions 201a projecting upwards along the vertical direction is connected to the eight positive terminals 104, i.e., the positive terminal 104 of the first thin battery 10a and the positive terminal 104 of the second thin battery 10b at the stack constituted of the first and second thin batteries 10a and 10b, the positive terminal 104 of the third thin battery 10c and the positive terminal 104 of the fourth thin battery 10d at the stack constituted of the third and fourth thin batteries 10c and 10d, the positive terminal 104 of the fifth thin battery 10e and the positive terminal 104 of the sixth thin battery 10f at the stack constituted of the fifth and sixth thin batteries 10e and 10f and the positive terminal 104 of the seventh thin battery 10g and the positive terminal 104 of the eighth thin battery 10h at the stack constituted of the seventh and eighth thin batteries 10g and 10h.

Likewise, the negative-side bus bar 202 is connected to the eight negative terminals 105, i.e., the negative terminal 105 of the first thin battery 10a and the negative terminal 105 of the second thin battery 10b at the stack constituted of the first and second thin batteries 10a and 10b, the negative terminal 105 of the third thin battery 10c and the negative terminal 105 of the fourth thin battery 10d at the stack constituted of the third and fourth thin batteries 10c and 10d, the negative terminal 105 of the fifth thin battery 10e and the negative terminal 105 of the sixth thin battery 10f at the stack constituted of the fifth and sixth thin batteries 10e and 10f and the negative terminal 105 of the seventh thin battery 10g and the negative terminal 105 of the eighth thin battery 10h at the stack constituted of the seventh and eighth thin batteries 10g and 10h.

As described above, the subassembly 20 in the second embodiment of the present invention includes the positive-side bus bar 201 having the two projecting portions 201a projecting upward along the vertical direction provided on the positive side and the flat negative-side bus bar 202 provided on the negative side, with all the terminals with matching polarity facing the same direction.

The subassembly 20 achieving the connections described above forms a circuit in which the eight thin batteries 10a˜10h are connected in parallel by the positive-side bus bar 201 and the negative-side bus bar 202 as shown in FIG. 18.

An assembly 30 explained below is formed by stacking a plurality of subassemblies 20 described above each constituting a component unit.

The following is an explanation of the procedure of stacking four subassemblies 20.

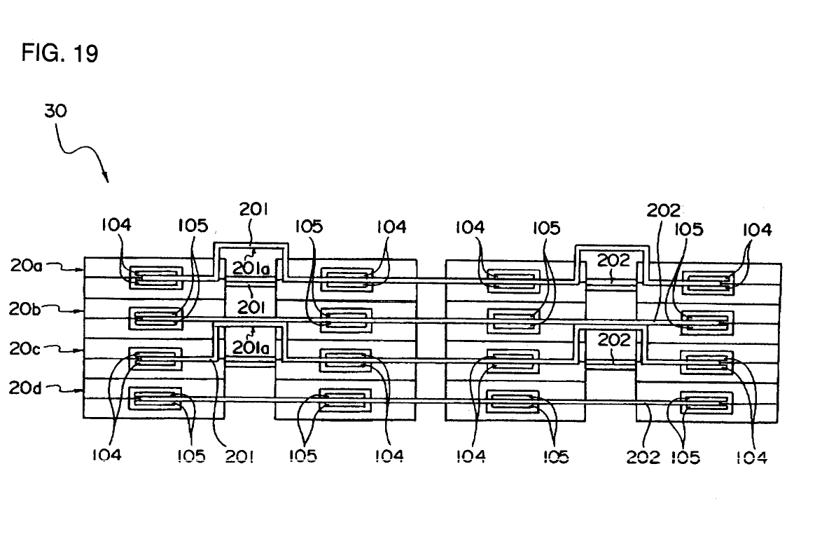

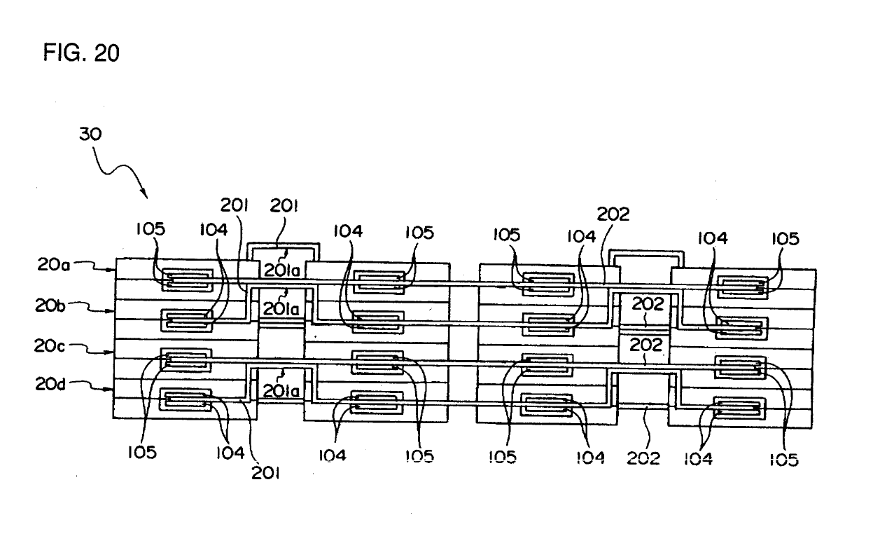

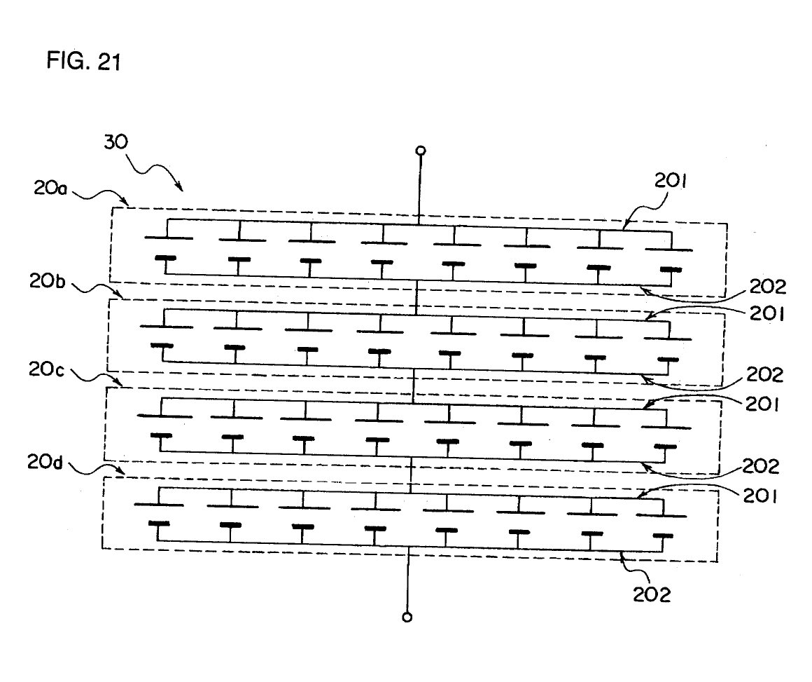

FIGS. 19 and 20 are side elevations of the assembly 30 achieved by stacking four subassemblies 20 in the second embodiment of the present invention. FIG. 21 is a circuit diagram of the assembly 30. As shown in FIGS. 19 and 20, with the positive side of the fourth subassembly 20d and the negative side of the third subassembly 20c facing the same direction and the two projecting portions 201a of the positive-side bus bar 201 at the fourth subassembly 20d projecting upward along the vertical direction, the third subassembly 20c is stacked on top of the fourth subassembly 20d. With the subassemblies stacked as described above, the two projecting portions 201a of the positive-side bus bar 201 provided at the fourth subassembly 20d come into contact with the negative-side bus bar 202 provided at the third subassembly 20c, thereby achieving a connection between the third subassembly 20c and the fourth subassembly 20d.

Next, with the positive side of the third subassembly 20c and the negative side of the second subassembly 20b facing the same direction and the two projecting portions 201a of the positive-side bus bar 201 at the third subassembly 20c projecting upward along the vertical direction, the second subassembly 20b is stacked on top of the third subassembly 20c. With the subassemblies stacked as described above, the two projecting portions 201a of the positive-side bus bar 201 provided at the third subassembly 20c come into contact with the negative-side bus bar 202 provided at the second subassembly 20b, thereby achieving a connection between the second subassembly 20b and the third subassembly 20c.

Then, with the positive side of the second subassembly 20b and the negative side of the first subassembly 20a facing the same direction and the two projecting portions 201a of the positive-side bus bar 201 at the second subassembly 20b projecting upward along the vertical direction, the first subassembly 20a is stacked on top of the second subassembly 20b. With the subassemblies stacked as described above, the two projecting portions 201a of the positive-side bus bar 201 provided at the second subassembly 20b come into contact with the negative-side bus bar 202 provided at the first subassembly 20a, thereby achieving a connection between the first subassembly 20a and the second subassembly 20b.

In the assembly 30 that includes the four subassemblies 20a˜20d stacked and connected so as to alternate the positive side and the negative side, the eight thin batteries 10a˜10h connected in parallel at the first subassembly 20a and the eight thin batteries 10a˜10h connected in parallel at the second subassembly 20b are connected in series through the contact between the negative-side bus bar 202 of the first subassembly 20a and the positive-side bus bar 201 of the second subassembly 20b which is achieved at two positions, as shown in FIG. 21. Likewise, through the contact between the negative-side bus bar 202 provided at each subassembly and the positive-side bus bar 201 at the adjacent subassembly, which is achieved at two positions, the eight thin batteries 10a˜10h connected in parallel at the second subassembly 20b, the eight thin batteries 10a˜10h connected in parallel at the third subassembly 20c and the eight thin batteries 10a˜10h connected in parallel at the fourth subassembly 20d are connected in series.

By providing a bus bar having projected portions with one polarity and providing a flat bus bar with the other polarity in each thin battery subassembly, it becomes possible to achieve both a parallel connection and a serial connection with a single type of component unit.

In addition, since subassemblies can be connected with ease by simply stacking the subassemblies having such bus bars one on top of another, a required voltage or the like can be realized readily.

The presence of the projecting portions formed at each positive-side bus bar increases the area between the positive-side bus bar and the negative-side bus bar set under the positive-side bus bar along the vertical direction compared to the area between two flat bus bars, and thus, sufficient space for connecting the bus bars is secured to further facilitate the connection work.

While a bus bar formed as a flat plate in a subassembly that includes thin batteries having their upper battery armors and lower battery armor constituted of a flexible material such as a resin film or a laminated product achieved by laminating resin-metal thin films poses a risk of damage to the terminals and the terminal seals of the thin batteries caused by deformation of the bus bar, such deformation of the bus bar can be prevented by forming a projecting portions at the bus bar, and consequently, damage to the thin batteries can be prevented.

With two projecting portions formed at each positive-side bus bar to allow a pair of a positive-side bus bar and a negative-side bus bar to achieve contact at two positions, the current density at the positive-side bus bar can be lowered.

(Third Embodiment)

The following is an explanation of an embodiment achieved by altering the shapes of the positive-side bus bar and the negative-side bus bar.

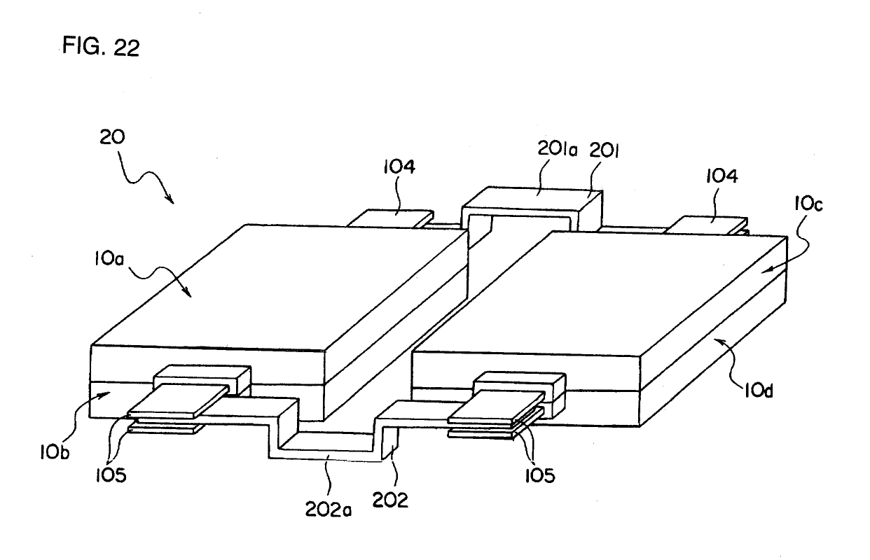

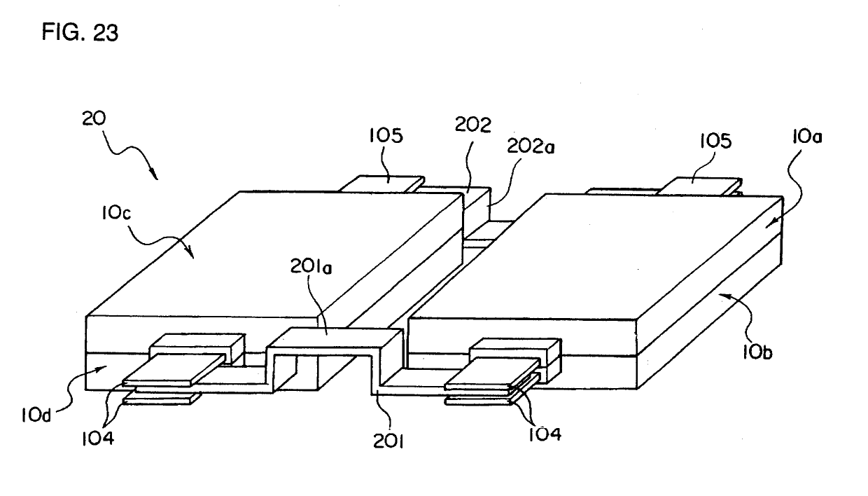

FIG. 22 is a perspective of a subassembly 20 achieved in the third embodiment of the present invention, viewed from the negative side and FIG. 23 is a perspective of the subassembly 20 in the third embodiment of the present invention viewed from the positive side.

As shown in FIGS. 22 and 23, the subassembly 20 in the third embodiment of the present invention comprises four thin batteries 10a˜10d, a positive-side bus bar 201 and a negative-side bus bar 202, with the thin batteries 10a˜10d adopting the structure similar to that of the thin batteries in the first embodiment. The positive-side bus bar 201 and the negative-side bus bar 202 are members that respectively connect the positive terminals 104 and the negative terminals 105 at the plurality of thin batteries 10a˜10d and are each constituted of an electrically conductive material such as metal.

As shown in FIG. 23, the positive-side bus bar 201 has a range which makes it possible for it to connect with all the positive terminals 104 present at the four thin batteries 10a˜10d. As shown in FIG. 22, the negative-side bus bar 202 has a range which makes it possible for it to connect with all the negative terminals 105 present at the four thin batteries 10a˜10d.

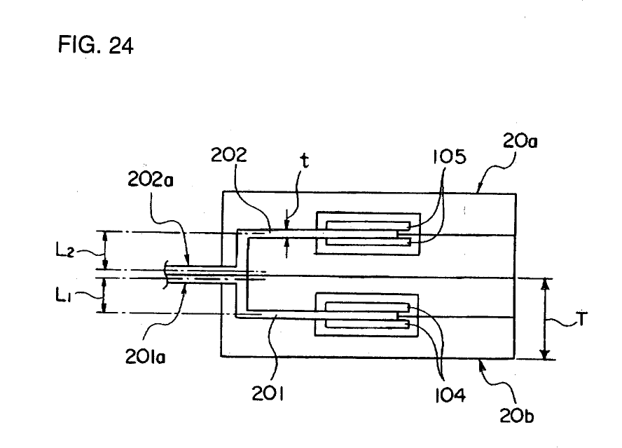

The positive-side bus bar 201 in the third embodiment of the present invention includes a projecting portion 201a formed to project upward along the vertical direction at its center. The negative-side bus bar 202, on the other hand, includes a projecting portion 202a formed to project downward along the vertical direction at its center. It is to be noted that, as shown in FIG. 24, the length L1 over which the projecting portion 201a of the positive-side bus bar 201 extends upward along the vertical direction is set to a value which allows the projecting portion 201a of the positive-side bus bar 201 at the subassembly 20 to come into full contact with the projecting portion 202a projecting downward along the vertical direction at another subassembly 20 when the other subassembly 20 is stacked on top of the subassembly 20 as detailed later. This length may be, for instance, a distance substantially equal to a numerical value calculated based upon the relational expression L1=(T−t)/2 with T representing the thickness of the subassembly 20 and t representing the plate thickness of the negative-side bus bar 202 when the plate thicknesses of the positive-side bus bar 201 and the negative-side bus bar 202 are substantially equal to each other at t. Likewise, the length L2 over which the projecting portion 202a of the negative-side bus bar 202 extends downward along the vertical direction is a distance that is substantially equal to a numerical value calculated based upon the relational expression L2=(T−t)/2. In other words, the length L1 over which the projecting portion 201a of the positive-side bus bar 201 extends and the length L2 over which the projecting portion 202a of the negative-side bus bar 202 extends substantially achieve a relationship expressed as; L1=L2=L/2.

Since the bus bars are formed in shapes identical to each other with the projecting portion 201a and the projecting portion 202a both projecting over the length of L1 provided at their centers, a single type of part can be used to constitute the positive-side bus bar 201 and the negative-side bus bar 202.

In the subassembly 20, the first thin battery 10a and the second thin battery 10b with its top side and bottom side reversed from those of the first thin battery 10a are stacked together so that their positive poles face the same direction, and likewise, the third thin battery 10c and the fourth thin battery 10d with its top side and bottom side reversed from those of the third thin battery 10c are stacked together so that their positive poles face the same direction.

With these two stacks with the positive poles facing the same direction, the positive-side bus bar 201 with its projecting portion 201a projecting upward along the vertical direction is connected to the positive terminal 104 of the first thin battery 10a and the positive terminal 104 of the second thin battery 10b of the stack constituted of the first and second thin batteries 10a and 10b. In the addition, the positive-side bus bar 201 is connected to the positive terminal 104 of the third thin battery 10c and the positive terminal 104 of the fourth thin battery 10d of the stack constituted of the third and fourth thin batteries 10c and 10d.

Likewise, the negative-side bus bar 202 with its projecting portion 202a projecting downward along the vertical direction is connected to the negative terminal 105 of the first thin battery 10a and the negative terminal 105 of the second thin battery 10b at the stack constituted of the first and second thin batteries 10a and 10b. In addition, the negative-side bus bar 202 is connected to the negative terminal 105 of the third thin battery 10c and the negative terminal 105 of the fourth thin battery 10d at the stack constituted of the third and fourth thin batteries 10c and 10d.

Thus, in the subassembly 20 achieved in the third embodiment of the present invention, the positive-side bus bar 201 with its projecting portion 201a projecting upward along the vertical direction is set on the positive side and the negative-side bus bar 202 with its projecting portion 202a projecting downward along the vertical direction is set on the negative side with all the terminals with matching polarity facing the same direction. The subassembly 20 achieving the connections described above forms a circuit in which the four thin batteries 10a˜10d are connected in parallel by the positive-side bus bar 201 and the negative-side bus bar 202, similar to the circuit of the subassembly in the first embodiment shown in FIG. 8.

An assembly 30 explained below is formed by stacking a plurality of subassemblies 20 described above each constituting a component unit.

The following is an explanation of the procedure of stacking four subassemblies 20.

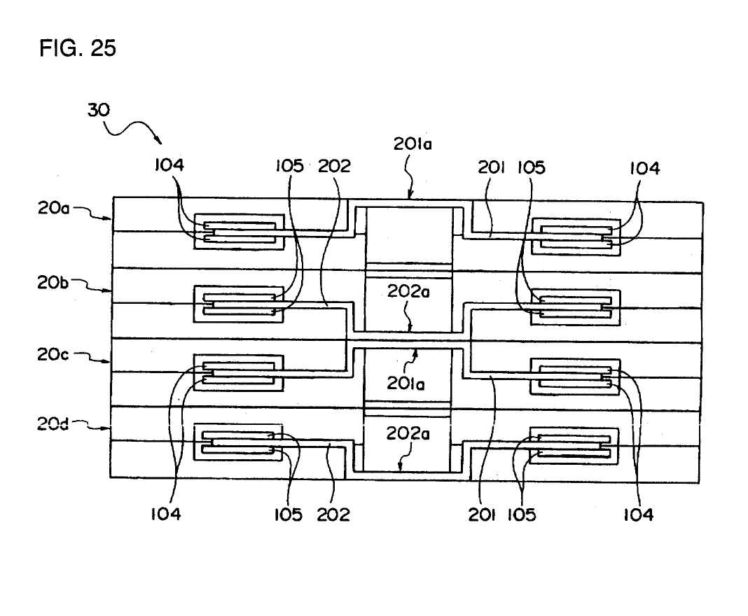

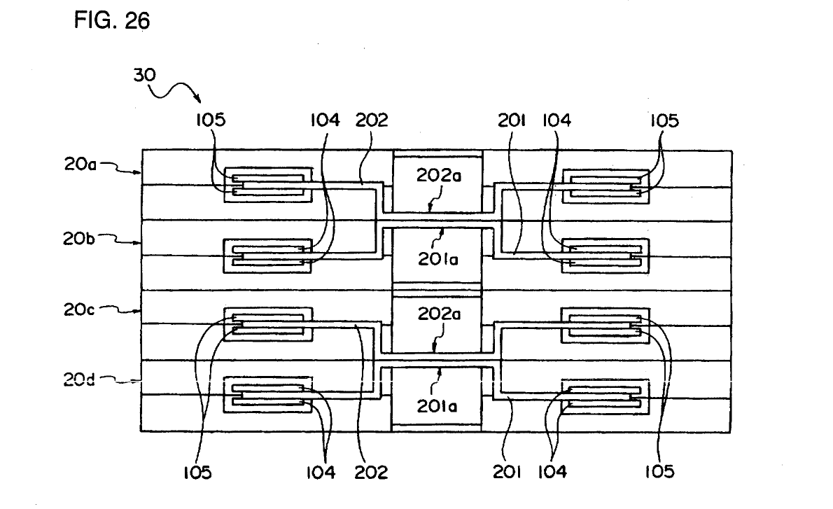

FIGS. 25 and 26 are side elevations of the assembly 30 achieved by stacking four subassemblies 20a˜20d in the third embodiment of the present invention.

As shown in FIGS. 25 and 26, the third subassembly 20c is stacked on top of the fourth subassembly 20d with the positive side of the fourth subassembly 20d and the negative side of the third subassembly 20c set to face the same direction, the projecting portion 202a of the negative-side bus bar 202 at the third subassembly 20c set to project downward along the vertical direction and the projecting portion 201a of the positive-side bus bar 201 at the fourth subassembly 20d set to project upward along the vertical direction. With the subassemblies stacked as described above, the projecting portion 201a projecting upward along the vertical direction at the positive-side bus bar 201 of the fourth subassembly 20d and the projecting portion 202b projecting downward along the vertical direction at the negative-side bus bar 202 of the third assembly 20c come into contact with each other, thereby achieving a connection between the third subassembly 20c and the fourth subassembly 20d.

Next, the second subassembly 20b is stacked on top of the third subassembly 20c with the positive side of the third subassembly 20c and the negative side of the second subassembly 20b set to face the same direction, the projecting portion 202a of the negative-side bus bar 202 at the second subassembly 20b set to project downward along the vertical direction and the projecting portion 201a of the positive-side bus bar 201 at the third subassembly 20c set to project upward along the vertical direction. With the subassemblies stacked as described above, the projecting portion 201a projecting upward along the vertical direction at the positive-side bus bar 201 of the third subassembly 20c and the projecting portion 202b projecting downward along the vertical direction at the negative-side bus bar 202 of the second assembly 20b come into contact with each other, thereby achieving a connection between the second subassembly 20b and the third subassembly 20c.

Then, the first subassembly 20a is stacked on top of the second subassembly 20b with the positive side of the second subassembly 20b and the negative side of the first subassembly 20a set to face the same direction, the projecting portion 202a of the negative-side bus bar 202 at the first subassembly 20a set to project downward along the vertical direction and the projecting portion 201a of the positive-side bus bar 201 at the second subassembly 20b set to project upward along the vertical direction. With the subassemblies stacked as described above, the projecting portion 201a projecting upward along the vertical direction at the positive-side bus bar 201 of the second subassembly 20b and the projecting portion 202b projecting downward along the vertical direction at the negative-side bus bar 202 of a first assembly 20a come into contact with each other, thereby achieving a connection between the first subassembly 20a and the second subassembly 20b.

In the assembly 30, which includes the four subassemblies 20a˜20d stacked and connected so as to alternate the positive side and the negative side as described above, the four thin batteries 10a˜10d connected in parallel at the first subassembly 20a and the four thin batteries 10a˜10d connected in parallel at the second subassembly 20b are connected in series through the contact between the negative-side bus bar 202 of the first subassembly 20a and the positive-side bus bar 201 of the second subassembly 20b, as in the circuit achieved in the first embodiment shown in FIG. 16. Likewise, through the contact between the negative-side bus bar 202 of each subassembly and the positive-side bus bar 201 of the adjacent subassembly, the four thin batteries 10a˜10d connected in parallel at the second subassembly 20b, the four thin batteries 10a˜10d connected in parallel at the third subassembly 20c and the four thin batteries 10a˜10d connected in parallel at the fourth subassembly 20d are connected in series.

With a bus bar having a projecting portion provided both on the positive side and on the negative side of each subassembly constituted of thin batteries, it becomes possible to achieve a parallel connection and a serial connection with a single type of component unit.

In addition, since subassemblies can be connected with ease by simply stacking the subassemblies having such bus bars one on top of another, a required voltage or the like can be realized readily.

Since a positive-side bus bar and a negative-side bus bar each having a projecting portion formed therein achieve contact with each other over the projecting portions, the area between the positive-side bus bar and the negative-side bus bar increases compared to the space achieved in the first embodiment. As a result, sufficient space for connecting the bus bars is assured to further facilitate the connecting work.

Furthermore, the projecting portions formed in the bus bars prevent the bus bars from becoming deformed even when the upper battery armors and the lower battery armors are constituted of a flexible material such as a resin film or a laminated product achieved by laminating resin-metal films, and thus, damage to the thin batteries can be prevented.

(Fourth Embodiment)

The following is an explanation of an embodiment of a subassembly constituted of eight thin batteries and having a positive-side bus bar and a negative-side bus bar formed in modified shapes.

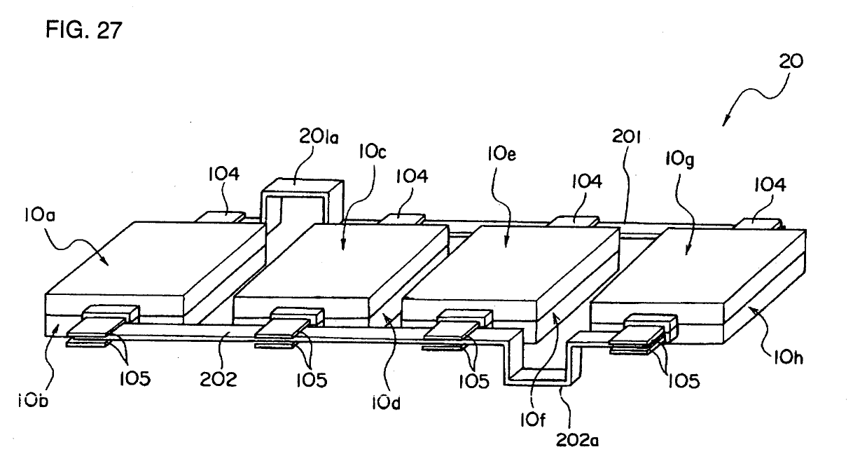

FIG. 27 is a perspective of the subassembly achieved in the fourth embodiment of the present invention, viewed from the negative side.

As shown in FIG. 27, the subassembly 20 in the fourth embodiment of the present invention comprises eight thin batteries 10a˜10h, a positive-side bus bar 201 and a negative-side bus bar 202, with the thin batteries 10a˜10h adopting the structure similar to that of the thin batteries in the first embodiment. The positive-side bus bar 201 and the negative-side bus bar 202 respectively are means for connecting the positive terminals 104 and the negative terminals 105 of the plurality of thin batteries 10a˜10h and are constituted of an electrically conductive material such as metal.

As shown in FIG. 27, the positive-side bus bar 201 has a range which makes it possible for it to connect with all the positive terminals 104 present at the four stacks constituted of the eight thin batteries 10a˜10h. Likewise, the negative-side bus bar 202 has a range which makes it possible for it to connect with all the negative terminals 105 present at the four stacks constituted of the eight thin batteries 10a˜10h.

The positive-side bus bar 201 includes a projecting portion 201a projecting upward along the vertical direction provided at a position offset from the center of the positive-side bus bar 201. The projecting portion 201a is positioned between the stack constituted of the first and second thin batteries 10a and 10b and the stack constituted of the third and fourth thin batteries 10c and 10d. The negative-side bus bar 202a, on the other hand, includes a projecting portion 202a projecting downward along the vertical direction provided at a position offset from the center of the negative-side bus bar 202. The projecting portion 202a is positioned between the stack constituted of the fifth and sixth thin batteries 10e and 10f and the stack constituted of the seventh and eighth thin batteries 10g and 10h. The length L over which the projecting portion 201a of the positive-side bus bar 201 extends upward along the vertical direction and the length L over which the projecting portion 202a of the negative-side bus bar 202 extends downward along the vertical direction are set as in the first embodiment.

Since the bus bars are formed in shapes identical to each other with the projecting portion 201a and the projecting portion 202b projecting over the length L, formed at positions offset from the centers of the bus bars, a single type of part can be used to constitute the positive-side bus bar 201 and the negative-side bus bar 202.

In the subassembly 20, the first thin battery 10a and the second thin battery 10b with its top side and bottom side reversed from those of the first thin battery 10a are stacked together so that their positive poles face the same direction. Likewise, the third thin battery 10c and the fourth thin battery 10d with its top side and bottom side reversed from those of the third thin battery 10c are stacked together so that their positive poles face the same direction. In addition, the fifth thin battery 10e and the sixth thin battery 10f with its top side and bottom side reversed from those of the fifth thin battery 10e are stacked together so that their positive poles face the same direction. Likewise, the seventh thin battery 10g and the eighth thin battery 10h with its top side and bottom side reversed from those of the seventh thin battery 10g are stacked together so that their positive poles face the same direction.

With the positive poles of the four stacks facing the same direction, the positive-side bus bar 201 is connected to the eight positive terminals 104, i.e., the positive terminal 104 of the first thin batteries 10a and the positive terminal 104 of the second thin battery 10b at the stack constituted of the first and second thin batteries 10a and 10b, the positive terminal 104 of the third thin battery 10c and the positive terminal 104 of the fourth thin battery 10d at the stack constituted of the third and fourth thin batteries 10c and 10d, the positive terminal 104 of the fifth thin battery 10e and the positive terminal 104 of the sixth thin battery 10f at the stack constituted of the fifth and sixth thin batteries 10e and 10f and the positive terminal 104 of the seventh thin battery 10g and the positive terminal 104 of the eighth thin battery 10h at the stack constituted of the seventh and eighth thin batteries 10g and 10h so that the projecting portion 201a is set projecting upward along the vertical direction between the stack constituted of the first and second thin batteries 10a and 10b and the stack constituted of the third and fourth thin batteries 10c and 10d.

Likewise, the negative-side bus bar 202 is connected to the eight negative terminals, i.e., the negative terminal 105 of the first thin batteries 10a and the negative terminal 105 of the second thin battery 10b at the stack constituted of the first and second thin batteries 10a and 10b, the negative terminal 105 of the third thin battery 10c and the negative terminal 105 of the fourth thin battery 10d at the stack constituted of the third and fourth thin batteries 10c and 10d, the negative terminal 105 of the fifth thin battery 10e and the negative terminal 105 of the sixth thin battery 10f at the stack constituted of the fifth and sixth thin batteries 10e and 10f and the negative terminal 105 of the seventh thin battery 10g and the negative terminal 105 of the eighth thin battery 10h at the stack constituted of the seventh and eighth thin batteries 10g and 10h so that the projecting portion 202a is set projecting downward along the vertical direction between the stack constituted of the fifth and sixth thin batteries 10e and 10f and the stack constituted of the seventh and eighth thin batteries 10g and 10h.

As a result, with the terminals with matching polarity all facing the same direction, the positive-side bus bar 201 with its projecting portion 201a projecting upward along the vertical direction formed at an offset position is set on the positive side and the negative-side bus bar 202 with its projecting portion 202a projecting downward along the vertical direction formed at an offset position is set on the negative side in the subassembly 20 in the fourth embodiment of the present invention. The subassembly 20 achieving the connections described above forms a circuit having the eight thin batteries 10a˜10h connected in parallel through the positive-side bus bar 201 and the negative-side bus bar 202, similar to the circuit of the subassembly achieved in the second embodiment shown in FIG. 18.

An assembly 30 explained below is formed by stacking a plurality of subassemblies 20 described above each constituting a component unit.

The following is an explanation of the procedure of stacking four subassemblies 20.

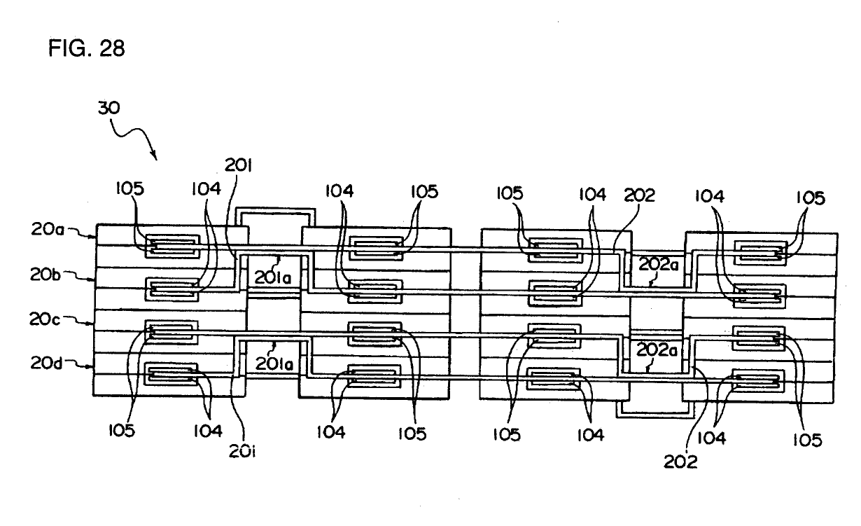

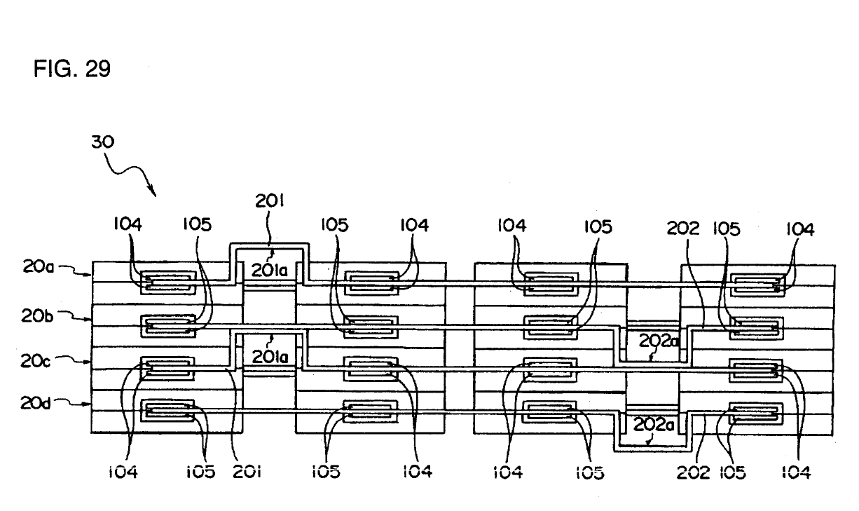

FIGS. 28 and 29 are side elevations of the assembly 30 achieved by stacking four subassemblies 20 in the fourth embodiment of the present invention.

As shown in FIGS. 28 and 29, with the positive side of the fourth subassembly 20d and the negative side of the third subassembly 20c set to face the same direction, the projecting portion 202a of the negative-side bus bar 202 at the third subassembly 20c projecting downward along the vertical direction and the projecting portion 201a of the positive-side bus bar 201 at the fourth subassembly 20d projecting upward along the vertical direction, the third subassembly 20c is stacked on top of the fourth subassembly 20d. With the subassemblies stacked as described above, the projecting portion 201a projecting upward along the vertical direction at the positive-side bus bar 201 of the fourth subassembly 20d comes into contact with the flat portion of the negative-side bus bar 202 provided at the third subassembly 20c. Also, the projecting portion 202a projecting downward along the vertical direction at the negative-side bus bar 202 of the third subassembly 20c comes into contact with the flat portion of the positive-side bus bar 201 provided at the fourth subassembly 20d, thereby achieving a connection between the third subassembly 20c and the fourth subassembly 20d.

Next, with the positive side of the third subassembly 20c and the negative side of the second subassembly 20b set to face the same direction, the projecting portion 202a of the negative-side bus bar 202 at the second subassembly 20b projecting downward along the vertical direction and the projecting portion 201a of the positive-side bus bar 201 at the third subassembly 20c projecting upward along the vertical direction, the second subassembly 20b is stacked on top of the third subassembly 20c. With the subassemblies stacked as described above, the projecting portion 201a projecting upward along the vertical direction at the positive-side bus bar 201 of the third subassembly 20c comes into contact with the flat portion of the negative-side bus bar 202 provided at the second subassembly 20b. Also, the projecting portion 202a projecting downward along the vertical direction at the negative-side bus bar 202 of the second subassembly 20b comes into contact with the flat portion of the positive-side bus bar 201 provided at the third subassembly 20c, thereby achieving a connection between the second subassembly 20b and the third subassembly 20c.

Then, with the positive side of the second subassembly 20b and the negative side of the first subassembly 20a set to face the same direction, the projecting portion 202a of the negative-side bus bar 202 at the first subassembly 20a projecting downward along the vertical direction and the projecting portion 201a of the positive-side bus bar 201 at the second subassembly 20b projecting upward along the vertical direction, the first subassembly 20a is stacked on top of the second subassembly 20b. With the subassemblies stacked as described above, the projecting portion 201a projecting upward along the vertical direction at the positive-side bus bar 201 of the second subassembly 20c comes into contact with the flat portion of the negative-side bus bar 202 provided at the first subassembly 20a. Also, the projecting portion 202a projecting downward along the vertical direction at the negative-side bus bar 202 of the first subassembly 20a comes into contact with the flat portion of the positive-side bus bar 201 provided at the second subassembly 20b, thereby achieving a connection between the first subassembly 20a and the second subassembly 20b.

In the assembly 30 that includes the four subassemblies 20a˜20d stacked and connected so as to alternate the positive sides and the negative sides, the eight thin batteries 10a˜10h connected in parallel at the first subassembly 20a and the eight thin batteries 10a˜10h connected in parallel at the second subassembly 20b are connected in series through the contact between the negative-side bus bar 202 of the first subassembly 20a and the positive-side bus bar 201 of the second subassembly 20b, as in the circuit in the second embodiment shown in FIG. 21. Likewise, through the contact between the negative-side bus bar 202 provided at each subassembly and the positive-side bus bar 201 at the adjacent subassembly, the eight thin batteries 10a˜10h connected in parallel at the second subassembly 20b, the eight thin batteries 10a˜10h connected in parallel at the third subassembly 20c and the eight thin batteries 10a˜10h connected in parallel at the fourth subassembly 20d are connected in series.

With a bus bar having a projecting portion provided both on the positive side and on the negative side of each subassembly constituted of thin batteries, it becomes possible to achieve a parallel connection and a serial connection with a single type of component unit.

Since subassemblies can be connected with ease by simply stacking the subassemblies having such bus bars one on top of another, a required voltage or the like can be realized readily.

The presence of the projecting portions at the positive-side bus bar and the negative-side bus bar increases the area between the positive-side bus bar and the negative-side bus bar, which makes it possible to secure sufficient space for connecting the bus bars to further facilitate the connecting work.

The projecting portions formed in the bus bars prevent the bus bars from becoming deformed even when the upper battery armors and the lower battery armors are constituted of a flexible material such as a resin film or a laminated product achieved by laminating resin-metal films, and thus, damage to the thin batteries can be prevented.

Since the projecting portions are formed at positions offset from the centers of the bus bars, a single type of part can be used to constitute both the positive-side bus bars and the negative-side bus bars and, as a result, a cost reduction can be achieved.

The number of thin batteries used to constitute a subassembly is not limited to four or eight as explained in reference to the first˜fourth embodiments, and the number of thin batteries can be set freely in conformance to the required capacity or the like. In addition, the quantities of the projecting portions projecting upward or downward along the vertical direction at the bus bars can be set as appropriate in conformance to the number of thin batteries used to constitute the subassembly or the like.

The number of subassemblies used to constitute an assembly is not limited to two or four as explained in reference to the first˜fourth embodiments, and the number of subassemblies can be set freely in conformance to the required voltage or the like, and these subassemblies can be connected with ease by stacking them one on top of another.

The embodiments described above are examples provided to facilitate understanding of the present invention and do not limit the scope of the present invention. Accordingly, the individual elements disclosed in the embodiments allow for all types of design modifications and replacements with equivalent elements within the technical scope of the present invention.

The disclosure of the following priority application is incorporated herein by reference:

Japanese Patent Application No. 2002-104912 filed Apr. 8, 2002.

What is claimed is:

1. A thin battery connection structure for electrically connecting a positive terminal and a negative terminal of one thin battery having the positive terminal and the negative terminal led out at peripheral portions of a battery armor each to either a positive terminal and a negative terminal of at least one other thin battery by using bus bars, wherein:
a projecting portion is formed at at least one bus bar of the bus bars, and
the projecting portion is used to achieve an electrical connection with another thin battery other than the tin batteries.

2. A thin battery connection structure according to claim 1, wherein:
a single projecting portion is formed at the one bus bar and is positioned at a gap between at least one pair of adjacent thin batteries.

3. A thin battery connection structure according to claim 1, wherein:
the one bus bar electrically connects N numbers of thin batteries with each other, and
at least two projecting portions are formed at the one bus bar each to be positioned at least two individual gaps among (N−1) numbers of gaps between adjacent thin batteries.

4. A thin battery connection structure according to claim 1, wherein:
the one thin battery and the one other thin battery are electrically connected with each other in parallel by the bus bars to constitute one battery pack,
one additional thin battery and one other additional battery are electrically connected in parallel by additional bus bars to constitute one other battery pack,
another battery pack is stacked on the one battery pack, and
the projecting portion formed at the bus bar of the one battery pack comes into contact with the one of additional bus bars of the other battery pack to electrically achieve a serial connection of the battery packs.

5. A thin battery connection structure according to claim 1, wherein:
the one thin battery and the other thin battery are electrically connected with each other in parallel by the bus bars to constitute a battery pack, and
the projecting portion is formed at both bus bars.

6. A thin battery connection structure according to claim 5, wherein:
the projecting portion formed at the one bus bar projects in one direction in which battery packs are stacked, and
the projecting portion formed at the other bus bar projects in an opposite direction to the one direction.

7. A thin battery connection structure according to claim 5, wherein:
the bus bars are formed in shapes substantially identical to each other.

8. A thin battery connection structure comprising at least a first thin battery connection structure and a second thin battery connection structure each defined in claim 6, wherein:
the first thin battery connection structure is stacked on the second thin battery connection structure, and
the projecting portions are electrically connected to achieve a serial connection of battery packs.

9. A battery pack comprising,
a plurality of thin batteries each having a positive terminal and a negative terminal led out at peripheral portions of a battery armor, and
bus bars electrically connecting in parallel the positive terminal and the negative terminal of one thin battery each to either a positive terminal or a negative terminal of at least one other thin battery, wherein:
a projecting portion is formed at at least one bus bar of the bus bars, and
the projecting portion is used to achieve an electrical connection with another battery pack.

10. A battery pack according to claim 9, wherein:
a single projecting portion is formed at the one bus bar and is positioned at a gap between at least one pair of adjacent thin batteries.

11. A battery pack according to claim 9, wherein:
one bus bar electrically connects N numbers of thin batteries with each other, and,
at least two projecting portions are formed at the one bus bar each to be positioned at least two individual gaps among (N−1) numbers of gaps between adjacent thin batteries.

12. A battery pack comprising at least a first battery pack and a second battery pack each defined in claim 9, wherein:
the first battery pack is stacked on the second battery pack and,
the projecting portion of the first battery pack comes into contact with the bus bar of the second battery pack to achieve a serial connection of the battery packs.

13. A battery pack according to claim 9, wherein:
the projecting portion is formed at both bus bars.

14. A battery pack according to claim 13, wherein:
the projecting portion formed at the one bus bar projects in one direction in which battery packs are stacked, and
the projecting portion formed at the other bus bar projects in an opposite direction to the one direction.

15. A battery pack according to claim 13, wherein:
the bus bars are formed in shapes substantially identical to each other.

16. A battery pack comprising a first battery pack and a second battery pack each defined in claim 14, wherein:
the projecting portion projecting in the one direction and the projecting portion projecting in the opposite direction are electrically connected with each other to achieve a serial connection of the first and second battery packs.

17. A battery pack comprising,
a first battery group of two thin batteries each having a positive terminal and a negative terminal led out at peripheral portions of a battery armor,
a second battery group of two thin batteries each having a positive terminal and a negative terminal led out at peripheral portions of a battery armor, and
two bus bars electrically connecting in parallel the positive terminals and the negative terminals of the first battery group of two thin batteries each to either positive terminals and negative terminals of the second battery group of two thin batteries, wherein:
a projecting portion is formed at at least one bus bar of the two bus bars, and
the projecting portion is used to achieve an electrical connection with another battery pack.

18. A battery pack comprising,
at least a first battery pack and a second battery pack each defined in claim 17, wherein:
the first battery pack and the second battery pack are stacked with each other,
the projecting portion is formed at both bus bars of each of the first battery pack and the second battery pack, in each battery pack, one projecting portion projects in one direction in which battery packs are stacked and the other projecting portion projects in an opposite direction to the one direction, and
the first battery pack and the second battery pack are electrically connected in series to each other by connecting the projection portion projecting in the one direction of the first battery pack to the projection portion projecting in the opposite direction of the second battery pack.
